(19) United States
(12) Patent Application Publication
(10) Pub. No.: US 2025/0219977 A1
(43) Pub. Date: Jul. 3, 2025

(54) USE OF CODELETS TO SOLVE INTEROPERABILITY PROBLEMS IN NETWORK FUNCTIONS

(71) Applicant: Microsoft Technology Licensing, LLC, Redmond, WA (US)

(72) Inventors: Bozidar RADUNOVIC, Cambridge (GB); Matthew Ian Ronald WILLIAMS, London (GB); Xenofon FOUKAS, Cambridge (GB)

(21) Appl. No.: 18/400,408

(22) Filed: Dec. 29, 2023

(51) Int. Cl. H04L 51/066; H04L 51/56

(52) U.S. Cl. CPC H04L 51/066; H04L 51/56

(57) ABSTRACT

A communications network utilizes codelets within a network function for correcting interoperability issues within standardized messages. A processor configured to execute the instructions for operating the network function receives a codelet for execution at a hook point for processing a standardized message within the instructions. The processor executes the codelet to determine that a message is incompatible with a local configuration or interpretation of the standardized message and to modify the message to be compatible with the local configuration or interpretation of the standardized message. The processor executes the network function to process the modified message.

### TECHNICAL FIELD

The present disclosure relates to communications networks and, in particular, use of codelets to solve interoperability problems in network functions.

### BACKGROUND

A radio access network (RAN) may provide multiple user devices with wireless access to a network such as a packet core network or a voice core network. The user devices may wirelessly communicate with a base station, which forwards the communications towards a core network. Conventionally, a base station in the RAN is implemented by dedicated processing hardware (e.g., an embedded system) located close to a radio unit including antennas. The base station may perform lower layer processing including physical (PHY) layer and media access control (MAC) layer processing for one or more cells. There may be costs associated with deploying dedicated processing hardware for each base station in a RAN, particularly for a RAN including small cells with relatively small coverage areas. Additionally, the dedicated processing hardware may be a single point of failure for the cell.

A virtualized radio access network may utilize an edge data center with generic computing resources for performing RAN processing for one or more cells. That is, instead of performing PHY and MAC layer processing locally on dedicated hardware, a virtualized radio access network may forward radio signals from the radio units to the edge data center for processing and similarly forward signals from the edge data center to the radio units for wireless transmission. In one specific example, cloud-computing environments can be used to provide mobile edge computing (MEC) where certain functions of a mobile network can be provided as workloads on nodes in the cloud-computing environment. In MEC, a centralized unit (CU) can be implemented in a back-end node, one or more distributed units (DUs) can be implemented in intermediate nodes, and various remote units (RU), which can provide at least PHY and/or MAC layers of a base station or other RAN node of the mobile network, can be deployed at edge servers. The RUs can communicate with the CU via one or more DUs. In an example, the DUs can provide higher network layer functionality for the RAN, such as radio link control (RLC) or packet data convergence protocol (PDCP) layer functions. The RUs can facilitate access to the CU for various downstream devices, such as user equipment (UE), Internet-of-Things (IoT) devices, etc.

Because the edge data center utilizes generic computing resources, a virtualized RAN may provide scalability and fault tolerance for base station processing. For example, the edge data center may assign a variable number of computing resources (e.g., servers) to perform PHY layer processing for the radio units associated with the edge data center based on a workload. Further, a virtualized RAN may implement multiple layers of RAN processing at a data center, enabling collection of multiple data feeds.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a computing system including: a memory storing computer-executable instructions for operating a network function; a processor configured to execute the instructions for operating the network function, wherein the processor is configured to: receive a codelet for execution at a hook point for processing a standardized message within the instructions for operating the network function; execute the codelet to: determine that a message is incompatible with a local configuration or interpretation of the standardized message; and modify the message to be compatible with the local configuration or interpretation of the standardized message; and process the modified message by the network function.

In some aspects, the techniques described herein relate to a method of correcting interoperability issues in standardized messages, including: receiving, at a computing device implementing a network function, a codelet for execution at a hook point for processing a standardized message within instructions for operating the network function; determining, by the codelet, that a message is incompatible with a local configuration or interpretation of the standardized message; modifying, by the codelet, the message to be compatible with the local configuration or interpretation of the standardized message; and processing the modified message by the network function. In some aspects, the techniques described herein relate to a computing system including: a memory storing computer-executable instructions for operating a network function; a processor configured to execute the instructions for operating the network function, wherein the processor is configured to: receive a codelet for execution at a hook point for processing a standardized message within the instructions for operating the network function; execute the codelet to: determine that a message is incompatible with a local configuration or interpretation of the standardized message; and modify the message to be compatible with the local configuration or interpretation of the standardized message; and process the modified message by the network function.

In some aspects, the techniques described herein relate to a method of correcting interoperability issues in standardized messages, including: receiving, at a computing device implementing a network function, a codelet for execution at a hook point for processing a standardized message within instructions for operating the network function; determining, by the codelet, that a message is incompatible with a local configuration or interpretation of the standardized message; modifying, by the codelet, the message to be compatible with the local configuration or interpretation of the standardized message; and processing the modified message by the network function.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example virtualized radio access network (vRAN) connecting a user equipment (UE) to a core network.

FIG. 2 is a diagram of a message compatibility codelet inserted into a message processing pipeline of a network function.

FIG. 3 is a flow diagram of an example of a method for correcting interoperability issues in standardized messages.

FIG. 4 illustrates an example of a computing device including additional optional component details.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to use of codelets to correct interoperability issues in standardizes messages within a network.

A key transformation of the Radio Access Network (RAN) in 5G is the migration to an Open RAN architecture, that sees the 5G RAN virtualized and disaggregated across multiple open interfaces. This approach fosters innovation by allowing multiple vendors to come up with unique solutions for different components at a faster pace. Furthermore, a new component introduced in the Open RAN architecture called a Radio Intelligent Controller (RIC) allows third parties to build new, vendor-agnostic monitoring and optimization use cases over interfaces standardized by O-RAN. As used herein, a network element refers to any entity within a network that communicates messages over an interface. For example, a user equipment (UE) such as a mobile phone may be a network element. A network function refers to a network element that provides connectivity. For example, a RAN may include multiple network functions such as a radio unit (RU), base station or node B. Further, the O-RAN architecture supports disaggregation and virtualization of network functions. For example, a virtual network function may be implemented on computing resources (e.g., memory and processors in a datacenter).

Despite this compelling vision, the opportunity for innovation still largely remains untapped because of two main challenges. The first challenge is related to the flexible data collection for monitoring and telemetry applications. The RAN functions can generate huge volumes of telemetry data at a high frequency (e.g., gigabytes per second). Collecting, transferring, and processing this data can put a strain on compute and network capacity. A conventional approach, standardized by the 3^{rd} generation partnership project (3GPP), defines a small set of aggregate cell key performance indicators (KPIs) collected every few seconds or minutes. The O-RAN RIC extends this idea by providing new KPIs at a finer time granularity. The O-RAN RIC may be classified as a near real-time RIC. Each KPI is defined through a service model (a form of API), most of them standardized by O-RAN. However, this approach is slow to evolve and does not scale well because of a limited number of initial use cases and a need to standardize new proposals. The second challenge is due to the real-time nature of many RAN control and data plane operations. Any new functionality added to these operations, in order to support a new service model, must be completed within a deadline, typically ranging from microseconds (μs) to a few milliseconds (ms). A deadline violation may cause performance degradation or even crash a vRAN. Any changes on these critical paths can create substantial design challenges and make RAN vendors reluctant to add new features.

Further, the Open RAN architecture implies participation by multiple vendors. Although standard setting organizations attempt to standardize communications between network elements to promote interoperability, there is potential for interoperability problems. For example, standards documents may specify complex signaling protocols involving messages with hierarchical and conditional structures. Such standards may be open to different interpretations or implementations by different vendors. There is also a possibility that a message is implemented incorrectly in a network element and not fully tested prior to release. For instance, an interoperability process may include connecting different network functions in a test setup and connecting the network functions using a set of pre-defined configuration parameters (depending on customer asks, etc.). If a network function is deployed in a network based on a different set of configuration parameters or customer asks, untested interoperability issues may arise.

Conventionally, if the connectivity with any of the parameters fail during interoperability testing, the vendors have to go back to engineering teams to fix the issues. This requires involvement of expensive engineering resources and long release cycles. If interoperability issues are discovered after deployment, errors due to the interoperability issues may require a release of a next version before the errors are resolved. For instance, a user equipment (UE) may not be able to attach to a network due to inconsistent interpretations of a capability message. The error may not be resolved until an update for one or both of the UE or the network function is released.

In an aspect, the present application provides a message compatibility codelet that is dynamically loaded at a hook point for execution within code of a network function for processing a standardized message. The network function executes the codelet to determine whether a message is incompatible with a local configuration or interpretation of the standardized message. The codelet can modify the message to be compatible with the local configuration or interpretation of the standardized message. The network function then processes the modified message.

Aspects of the present disclosure may be implemented to realize one or more of the following technical effects. A message compatibility codelet can be dynamically loaded to a deployed network function to resolve an interoperability issue in a shorter amount of time than releasing a new version of the network function. Accordingly, interoperability issues may be resolved to improve performance of the network, for example, by allowing a device to communicate on the network or achieve better performance, depending on the interoperability issue. In implementations where the message compatibility codelet executes on the same processor core as the network function (or message processing component thereof), the latency for analyzing and modifying a message may be kept within constraints for wireless networks.

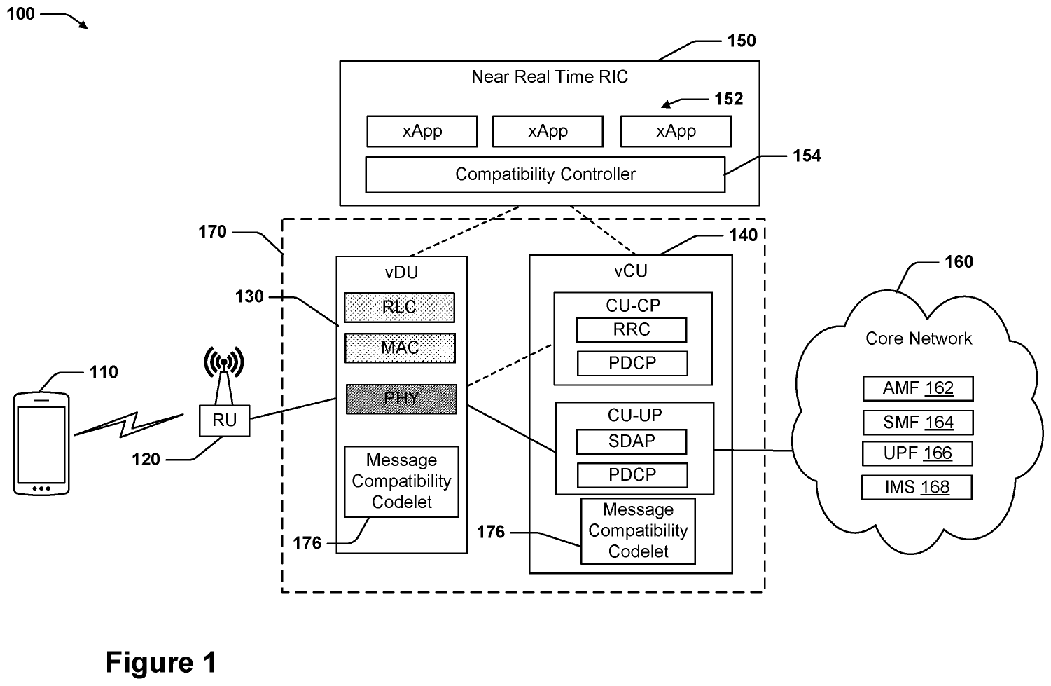

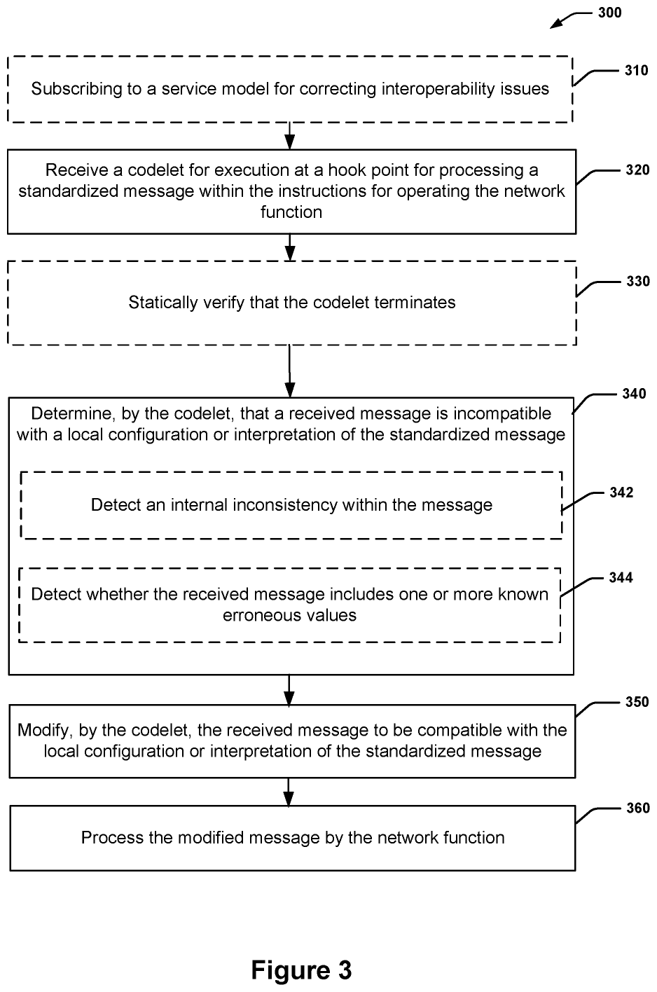

Turning now to FIGS. 1-4, examples are depicted with reference to one or more components and one or more methods that may perform the actions or operations described herein, where components and/or actions/operations in dashed line may be optional. Although the operations described below in FIG. 3 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and a software component capable of performing the described actions or functions.

FIG. 1 is a diagram of an example vRAN 100 connecting a user equipment (UE) 110 to a core network 160. The vRAN 100 includes multiple virtual network functions that may be configured to host a message compatibility codelet 176 for resolving interoperability issues. The vRAN 100 may include radio units (RU) 120 that transmit and receive wireless signals with the UE 110. The vRAN 100 may include a virtual distributed unit (vDU) 130 that performs processing, for example, at the physical (PHY) layer, media access control (MAC) layer, and radio link control (RLC) layer. The vRAN 100 may include a virtual central unit (vCU) 140 that performs processing at higher layers of the wireless protocol stack. The vRAN 100 may include a near real-time RAN intelligent control (RIC) 150 that performs autonomous configuration and optimization of the vRAN 100. The vRAN 100 may be implemented on resources 170 of an underlying communications network. For example, the resources 170 may include servers or server racks containing processors and memory hosted in datacenters, which are connected via communication links and routers. The near real-time RIC 150 may be part of a service management and orchestration (SMO) platform. The core network 160 may also include network functions. For example, the core network 160 may be a packet core and include network functions such as an Access and Mobility Management Function (AMF) 162, a Session Management Function (SMF) 164, and a User Plane Function (UPF) 166. As another example, the core network 160 may be a voice core including an IP multimedia system (IMS) 168 and associated network functions.

The division of functionality between the vDU 130 and the vCU 140 may depend on a functional split architecture. The vCU 140 may be divided into a central unit control plane (CU-CP) and central unit user plane (CU-UP). CU-UP may include the packet data convergence protocol (PDCP) layer and the service data adaptation (SDAP) layer, and the radio resource control (RRC) layer. Different components or layers may have different latency and throughput requirements. For example, the PHY layer may have latency requirements between 125 μs and 1 ms and a throughput requirement greater than 1 Gbps, the MAC and RLC layers may have latency requirements between 125 μs and 1 ms and a throughput requirement greater than 100 Mbps, and the higher layers at the vCU may have latency requirements greater than 125 μs and a throughput requirement greater than 100 Mbps.

Programmability in Open RAN components may be facilitated through the near real-time RIC 150. A network operator can install applications (Apps 152, e.g., xApps in Open RAN) on top of the near real-time RIC 150, which may collect detailed telemetry and may leverage the telemetry to optimize network performance or report issues in near real-time (e.g., >10 ms to seconds). The data collection and control of the vRAN components may be facilitated through service models that must be embedded in the vRAN functions by vendors. The service models may explicitly define the type and frequency of data reporting for each App 152, as well as a list of control policies that the RIC can use to modify the RAN behavior. Each App 152 may specify its own service model, requiring the collection of different telemetry data. The initial xApps proposed for standardization by Open RAN focus on optimizing handovers, self-organizing network (SON) functionality, anomaly detection, and coarse grained radio resource allocation. In these use cases, significant network events occur at a low rate (100s of ms to seconds). The volume of generated telemetry data is low, and all the data are transported to the RIC. This allows Apps 152 to have a full insight into the domain and tune the vRAN functions through a pre-determined set of control policies. Unfortunately, this approach does not scale to many other use cases of RAN monitoring and control for two main reasons.

Firstly, for many lower layer applications (e.g., PHY and MAC), it is inefficient to transport all the data to the near real-time RIC 150 due to the sheer volume of data. For example, applications like localization, channel estimation, interference detection, and beamforming may require uplink IQ samples from the physical layer. Transporting all IQ samples to the RIC requires more than 5 Gbps per cell for 100 MHz 4×4 MIMO. The standard near real-time RIC design overcomes this problem by specifying in the service model of each App the data required in terms of type and frequency (e.g., in a raw or a pre-processed format). The form of pre-processing (e.g., sub-sampling, averages, or subsets of data) greatly depends on the service model, posing a serious limitation to interoperability because vRAN vendors must implement and support each proprietary service model.

Secondly, many real-time control loops (e.g., packet scheduling and power control), have very tight time constraints (<10 ms). Such time constraints cannot be met by the standard near real-time RIC design that has an expected latency in the order of hundreds of milliseconds. As in the case of telemetry, the App choice of control policy is limited by a set of (standardized) policies that the appropriate service model of the RIC provides. vRAN vendors must implement and integrate such algorithms in their stack, while ensuring that they do not affect the run time performance of the vRAN component. This framework of services models implanted by the vRAN vendor makes it very difficult to practically implement new custom variants of tight control loops. For example, it would not be practical to export message processing from a network function to a near real-time RIC due to the load on the network and latency. Accordingly, there is a need to dynamically adapt network functions to address interoperability issues.

In an aspect, the present disclosure provides for a message compatibility codelet 176 that is executed within the virtual radio network functions (e.g., vDU 130, vCU 140, AMF 162, SMF 164, or UPF 166). The message compatibility codelet 176 is loaded to a hook point of the network function where the codelet 176 has access to incoming or outgoing messages. For example, the message compatibility codelet 176 may access a message buffer to evaluate a message to determine whether the message is incompatible with a local configuration or interpretation of a standardized message. For instance, the message compatibility codelet 176 may be configured to detect an internal inconsistency within the message or detect whether the message includes one or more known erroneous values. Accordingly, the message compatibility codelet 176 may detect interoperability issues of messages within a network function. Further, the message compatibility codelet 176 may correct errors transparently to the operation of the network function with low latency that satisfies latency requirements of the network function.

In an implementation, the message compatibility codelet 176 is an extended Berkeley packet filter (eBPF) codelet. The eBPF codelet executes within the user space of the network function. The eBPF codelet may be referred to as a user-space Berkeley packet filter (uBPF) codelet. The network function may be configured with one or more hook points that allow access to a message. For instance, the hook point may be a location between the instructions for the network function where a message is stored in memory or retrieved from memory. A hook point may be associated with a block of instructions. For instance, a hook point may be included in the code that receives packets, forwards packets, verifies session performance, etc.

In some implementations, the message compatibility codelet 176 may be provided by a compatibility controller 154. For instance, the compatibility controller 154 may be an xApp executed on the Near Real Time RIC 150. The compatibility controller 154 may be associated with a service model that identifies requirements of a hook point for deploying the message compatibility codelet 176. A network function that satisfies the requirements may subscribe to the compatibility controller 154 to dynamically receive the message compatibility codelet 176, for example, when an interoperability issue is discovered for the network function or another network element in communication with the network function. In some implementations, the network function advertises a service model with a hook point at which messages can be accessed by the message compatibility codelet 176. The compatibility controller 154 may dynamically load or update the message compatibility codelet 176 according to the service model as interoperability issues are discovered and/or resolved.

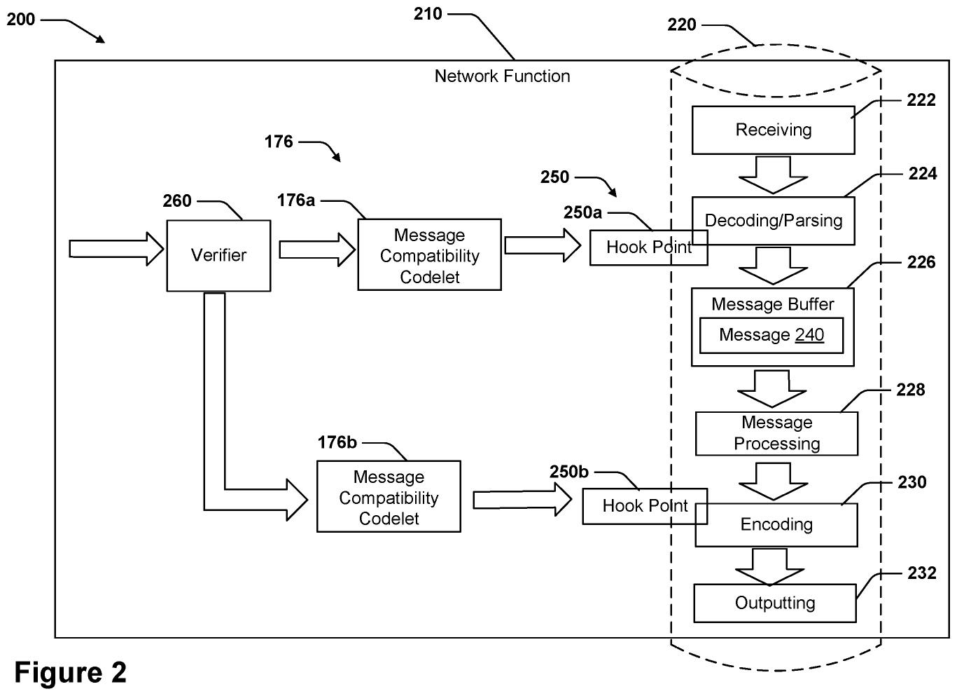

FIG. 2 is a diagram 200 of a message compatibility codelet 176 inserted into a message processing pipeline 220 of a network function 210. In general, a network function includes a message processing pipeline 220 for performing the particular role for the network function. Message processing may be performed for either an uplink direction or a downlink direction, and a network function may include multiple processing pipelines corresponding to different types or sources of messages. The message processing pipeline 220 may include a receiving block 222, a decoding/parsing block 224, a message buffer 226, a message processing block 228, an encoding block 230, and an outputting block 232.

The receiving block 222 may receive a message from another network element via an interface. The interface may vary based on the particular network function and architecture split. The receiving block 222 may perform error correction to ensure that the message was correctly received (e.g., the bits of the received message are the same as the bits of the transmitted message).

The decoding/parsing block 224 may analyze a received message to determine contents of the message such as information elements. The information elements may be defined by a standards document. For example, the standards document may describe the structure of the message in terms of which information elements are included. The standards document may further specify permitted values of the information elements. The decoding/parsing block 224 may analyze the information elements to determine whether the message includes correctly structured information. For example, the decoding/parsing block 224 may detect whether a value of an information element is a permitted value. The decoding/parsing block 224 may store the parsed message in the message buffer 226, which may be, for example, a first-in-first-out (FIFO) buffer.

The message processing block 228 may receive a message 240 from the message buffer 226 and perform substantive processing for the network function. For example, the message processing block 228 may make policy decisions based on the information elements of the message 240.

The encoding block 228 may encode a second message in response to the message 240. For instance, the outputting block 230 may generate an acknowledgement or response to the network element that sent the message 240. As another example, the outputting block 230 may modify the message 240 and/or forward the message 240 to another network element.

The outputting block 232 may process the second message based on an interface. For example, the outputting block may generate an IP packet or radio packet based on the interface for the outgoing second message.

The network function 210 may include a verifier 260 configured to statically verify a received message compatibility codelet 176. For instance, the verifier 260 may be an eBPF verifier that verifies that the received message compatibility codelet 176 will deterministically terminate. In some implementations, the verifier 260 may ensure that the received message compatibility codelet 176 will terminate within a latency that satisfies a latency requirement of the network function 210. In an aspect, the verification allows the message compatibility codelet 176 to be executed on the same processor core as the network function 210. This in-line execution results in lower compute costs and lower latency and jitter as the message does not need to be copied and the codelet does not compete with other processes.

In an aspect, the message processing pipeline 220 is configured with one or more hook points 250 (e.g., hook points 250a or 250b) within the instructions for operating the network function. That is, the hook point 250 may be a point within the code for one of the blocks of the processing pipeline 220. For example, the decoding/parsing block 224 may include a hook point 250a after the message 240 is stored in the message buffer 226. In some implementations, the hook point 250a may be located before the decoding/parsing block 224 to allow analysis of a raw message.

The hook point 250a may allow the message compatibility codelet 176a to analyze a received message to determine whether the received message is incompatible with a local configuration or interpretation of the standardized message. For example, the message compatibility codelet 176 may check whether received information elements are internally consistent. For instance, a first information element may indicate a capability or action defined by a value of a second information element. The message compatibility codelet 176 may check whether the value of the second information element is consistent with the indication of the first information element. As another example, if the network element that sent the message 240 is known to include an erroneous value for an information element under certain conditions, the message compatibility codelet 176 may check whether the message 240 includes the known erroneous value for the information element. When the hook point 250a is located before the decoding/parsing block 224, the message compatibility codelet 176 may correct issues that could cause a parsing error.

The message processing block 228 may include a hook point 250b, for example, after the message processing block 228 has generated a new message. For instance, the hook point 250b may be associated with the encoding block 230. In some implementations, the message processing block 228 may generate an interoperability issue. For example, the message processing block 228 may set a value of an information element that is valid under a standard but is not accepted by another network element that is to receive the message. As another example, the other network element may require a particular order of information elements or produce a better result if the information elements are listed in a certain order. The hook point 250b may allow the message compatibility codelet 176b to check for interoperability issues in outgoing messages.

An example of an interoperability issue that may be corrected by the message compatibility codelet 176 is a non-standards compliant UE capability information response of UE at the RRC layer. For example, during an attachment procedure (e.g., initial access) the UE 110 may transmit a UE capability response message that reaches the vCU 140 at the RRC layer. The vDU 130 and RU 120 may provide a gNB using band n78 with 100 MHz bandwidth. the vCU 140 sends an RRCReconfiguration message to the UE 110 containing a UE capability information request. This is an important message during the attachment process, so that the vCU 140 can understand the capabilities of the UE 110 and can configure the UE 110 accordingly. The UE 110 responds to this request with a UE capability information response, that, among others, contains a list of band combinations. Band n78 (the one supported) is one valid combination. This band combination is mapped to featureSetCombination 0. The featureSetCombination points to another IE of the response, that describes the capabilities of the UE for band n78. For example, the featureSetCombination 0 (Item 0) lists a downlinkSetNR parameter. The parameter downlinkSetNR indicates the features that the UE supports on the carriers of band n78 for the DL direction. According to the 3GPP specification (e.g., TS 38.311), if the parameter downlinkSetNR is 0, it means that this band is not supported, while a value of 1, points to the first item (Item 0) of another part of the message, called featureSetsDownlink. Similarly to the previous case, the parameter FeatureSetDownlinkPerCC-Id for Item 0 is set to 1, pointing to Item 0 of another IE called featureSetsDownlinkPerCC. However, in that part of the message, the UE reports that for band n78 it can only support 50 MHz bandwidth, and not 100 MHz, which is Item 2 (i.e., value 3 for FeatureSetDownlinkPerCC-Id). As a result, the vCU 140 rejects this UE 110, due to lack of support of 100 MHz. However, this UE 110 does support 100 MHz for band n78 in reality, and the UE 110 simply sends a message that is not well aligned with the 3GPP standards (e.g., due to an error in a single reported value among several similarly named parameters and lack of thorough testing of the UE capability information responses for all the bands). In an aspect, the message compatibility codelet 176 may modify the value of parameter FeatureSetDownlinkPerCC-Id from the value of 1 and set the value of parameter FeatureSetDownlinkPerCC-Id to 3. Accordingly, with the modified message, the UE 110 can attach successfully to the gNB and achieve full DL throughput.

FIG. 3 is a flow diagram of an example of a method 300 for using codelets to solve interoperability problems in virtual network functions. For example, the method 300 can be performed by a computing system such as resources 170 hosting a network function 210 and/or one or more components thereof.

At block 310, the method 300 may optionally include subscribing to a service model for correcting interoperability issues. In an example, the network function 210 can subscribe to a service model for correcting interoperability issues. For instance, the network function 210 may be an E2 agent of the near-real-time RIC 150. The network function 210 may inform the near-real-time RIC 150 and/or the compatibility controller about hook points 250 that allow the network function 210 execute a codelet for analyzing and modifying messages for interoperability. Accordingly, the compatibility controller 154 may be aware of the capability to execute a codelet and may push codelets to the network function 210.

At block 320, the method 300 includes receiving a codelet for execution at a hook point for processing a standardized message within the instructions for operating the network function. In an example, the network function 210 can receive a codelet (e.g., message compatibility codelet 176) for execution at a hook point 250 for processing a standardized message 240 within the instructions for operating the network function 210.

At block 330, the method 300 may optionally include statically verifying that the codelet terminates. In an example, the network function 210 and/or the verifier 260 can statically verify that the codelet terminates. For instance, the verifier 260 may perform eBPF verification on the message compatibility codelet 176.

At block 340, the method 300 includes determining, by the codelet, that a message is incompatible with a local configuration or interpretation of the standardized message. For example, the network function 210 can execute the message compatibility codelet 176 to determine that a message 240 is incompatible with a local configuration or interpretation of the standardized message. For instance, the network function 210 may execute the 176 for each message during or after the decoding/parsing block 224. In some implementations, at sub-block 342, the network function 210 may detect an internal inconsistency within the message. In some implementations, at sub-block 344, the network function 210 may detect whether the message includes one or more known erroneous values.

At block 350, the method 300 includes modifying, by the codelet, the message to be compatible with the local configuration or interpretation of the standardized message. In an example, the network function 210 can execute the message compatibility codelet 176 to modify the message 240 to be compatible with the local configuration or interpretation of the standardized message. In some implementations, the message compatibility codelet 176 may include an associated correction with each identified error. In some implementations, the corrections have been tested for interoperability and to ensure that the correction does not create additional interoperability issues.

At block 360, the method 500 includes processing the modified message by the network function. In an example, the network function 210 can process the modified message in block 228. For instance, block 228 of the processing pipeline 220 may process the modified message 240 as if the modified message has originally been received. That is, the modification to the message 240 may be transparent to the message processing block 228. Similarly, the outputting block 230 may perform any processing on the message 240 (e.g., forwarding) as if the modified message 240 had been the originally received message.

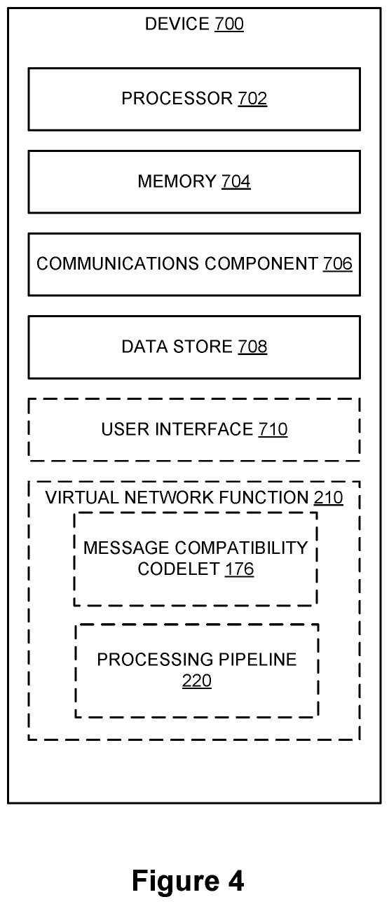

FIG. 4 illustrates an example of a device 400 including additional optional component details. In one aspect, device 400 may include one or more processors 402, which may be processor cores for carrying out processing functions associated with one or more of components and functions described herein. Processor(s) 402 can include a single or multiple set of processors or multi-core processors. Moreover, processor(s) 402 can be implemented as an integrated processing system and/or a distributed processing system.

Device 400 may further include one or more memory/memories 404 for storing local versions of operating systems (or components thereof) and/or applications being executed by processor(s) 402, such as RAN virtual network functions 210, etc. Memory/memories 404 can include a type of memory usable by a computer, such as random access memory (RAM), read only memory (ROM), tapes, magnetic discs, optical discs, volatile memory, non-volatile memory, and any combination thereof.

Further, device 400 may include a communications component 406 that provides for establishing and maintaining communications with one or more other devices, parties, entities, etc. utilizing hardware, software, and services as described herein. Communications component 406 may carry communications between components on device 400, as well as between device 400 and external devices, such as devices located across a communications network and/or devices serially or locally connected to device 400. For example, communications component 406 may include one or more buses, and may further include transmit chain components and receive chain components associated with a wireless or wired transmitter and receiver, respectively, operable for interfacing with external devices.

Additionally, device 400 may include a data store 408, which can be any suitable combination of hardware and/or software, that provides for mass storage of information, databases, and programs employed in connection with aspects described herein. For example, data store 408 may be or may include a data repository for operating systems (or components thereof), applications, related parameters, etc. not currently being executed by processor(s) 402. In addition, data store 408 may be a data repository for virtual network functions 210, message compatibility codelet 176, and/or one or more other components of the device 400.

Device 400 may optionally include a user interface component 410 operable to receive inputs from a user of device 400 and further operable to generate outputs for presentation to the user. User interface component 410 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 710 may include one or more output devices, including but not limited to a display, a speaker, a haptic feedback mechanism, a printer, any other mechanism capable of presenting an output to a user, or any combination thereof.

Device 400 may additionally include the RAN virtual network function 210 configured with the codelet 176 for detecting interoperability issues in standardized messages and modifying the messages to resolve the interoperability issues.

The following numbered clauses provide an overview of aspects of the present disclosure:

Clause 1. A computing system comprising: a memory storing computer-executable instructions for operating a network function; a processor configured to execute the instructions for operating the network function, wherein the processor is configured to: receive a codelet for execution at a hook point for processing a standardized message within the instructions for operating the network function; execute the codelet to: determine that a message is incompatible with a local configuration or interpretation of the standardized message, and modify the message to be compatible with the local configuration or interpretation of the standardized message; and process the modified message by the network function.

Clause 2. The computing system of clause 1, wherein the standardized message includes a plurality of information elements and the codelet is configured to evaluate values of the information elements.

Clause 3. The computing system of clause 1 or 2, wherein the processor executes the codelet on a same processor core as the network function.

Clause 4. The computing system of any of clauses 1-3, wherein the standardized message is an outgoing message and the hook point is associated with instructions for encoding the outgoing message.

Clause 5. The computing system of any of clauses 1-3, wherein the standardized message is an incoming message and the hook point is associated with instructions for decoding or parsing the incoming message.

Clause 6. The computing system of any of clauses 1-5, wherein the hook point has access to a message buffer storing the standardized message.

Clause 7. The computing system of any of clauses 1-6, wherein the processor is configured to statically verify that the codelet terminates.

Clause 8. The computing system of any of clauses 1-7, wherein to determine that a message is incompatible with a local configuration or interpretation of the standardized message, the codelet is configured to detect an internal inconsistency within the message.

Clause 9. The computing system of any of clauses 1-8, wherein to determine that a message is incompatible with a local configuration or interpretation of the standardized message, the codelet is configured to detect whether the message includes one or more known erroneous values.

Clause 10. The computing system of any of clauses 1-9, wherein the processor is configured to advertise a service model for correcting interoperability issues.

Clause 11. A method of correcting interoperability issues in standardized messages, comprising: receiving, at a computing device implementing a network function, a codelet for execution at a hook point for processing a standardized message within instructions for operating the network function; determining, by the codelet, that a message is incompatible with a local configuration or interpretation of the standardized message; modifying, by the codelet, the message to be compatible with the local configuration or interpretation of the standardized message; and processing the modified message by the network function.

Clause 12. The method of clause 11, wherein the standardized message includes a plurality of information elements and the codelet is configured to evaluate values of the information elements.

Clause 13. The method of clause 11 or 12, wherein executing the codelet uses a same processor core as the network function.

Clause 14. The method of any of clauses 11-13, wherein the standardized message is an outgoing message and the hook point is associated with instructions for encoding the outgoing message.

Clause 15. The method of any of clauses 11-13, wherein the standardized message is an incoming message and the hook point is associated with instructions for decoding or parsing the incoming message.

Clause 16. The method of any of clauses 11-15, wherein the hook point has access to a message buffer storing the standardized message.

Clause 17. The method of any of clauses 11-16, further comprising statically verifying that the codelet deterministically terminates.

Clause 18. The method of any of clauses 11-17, wherein to determining that the message is incompatible with a local configuration or interpretation of the standardized message comprises detecting an internal inconsistency within the message.

Clause 19. The method of any of clauses 11-18, wherein to determining that the message is incompatible with a local configuration or interpretation of the standardized message comprises detecting that the message includes one or more known erroneous values.

Clause 20. The method of any of clauses 11-19, further comprising advertising a service model for correcting interoperability issues.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer readable media specifically exclude transitory signals.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the claim language. Reference to an element in the singular is not intended to mean “one and only one” unless specifically so stated, but rather “one or more.” Unless specifically stated otherwise, the term “some” refers to one or more. Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computing system comprising:
a memory storing computer-executable instructions for operating a network function;
a processor configured to execute the instructions for operating the network function, wherein the processor is configured to:
receive a codelet for execution at a hook point for processing a standardized message within the instructions for operating the network function;
execute the codelet to:
determine that a message is incompatible with a local configuration or interpretation of the standardized message, and
modify the message to be compatible with the local configuration or interpretation of the standardized message; and
process the modified message by the network function.

2. The computing system of claim 1, wherein the standardized message includes a plurality of information elements and the codelet is configured to evaluate values of the information elements.

3. The computing system of claim 1, wherein the processor executes the codelet on a same processor core as the network function.

4. The computing system of claim 1, wherein the standardized message is an outgoing message and the hook point is associated with instructions for encoding the outgoing message.

5. The computing system of claim 1, wherein the standardized message is an incoming message and the hook point is associated with instructions for decoding or parsing the incoming message.

6. The computing system of claim 1, wherein the hook point has access to a message buffer storing the standardized message.

7. The computing system of claim 1, wherein the processor is configured to statically verify that the codelet terminates.

8. The computing system of claim 1, wherein to determine that the message is incompatible with a local configuration or interpretation of the standardized message, the codelet is configured to detect an internal inconsistency within the message.

9. The computing system of claim 1, wherein to determine that the message is incompatible with a local configuration or interpretation of the standardized message, the codelet is configured to detect whether the message includes one or more known erroneous values.

10. The computing system of claim 1, wherein the processor is configured to advertise a service model for correcting interoperability issues.

11. A method of correcting interoperability issues in standardized messages, comprising:
receiving, at a computing device implementing a network function, a codelet for execution at a hook point for processing a standardized message within instructions for operating the network function;
determining, by the codelet, that a message is incompatible with a local configuration or interpretation of the standardized message;
modifying, by the codelet, the message to be compatible with the local configuration or interpretation of the standardized message; and
processing the modified message by the network function.

12. The method of claim 11, wherein the standardized message includes a plurality of information elements and the codelet is configured to evaluate values of the information elements.

13. The method of claim 11, wherein executing the codelet uses a same processor core as the network function.

14. The method of claim 11, wherein the standardized message is an outgoing message and the hook point is associated with instructions for encoding the outgoing message.

15. The method of claim 11, wherein the standardized message is an incoming message and the hook point is associated with instructions for decoding or parsing the incoming message.

16. The method of claim 11, wherein the hook point has access to a message buffer storing the standardized message.

17. The method of claim 11, further comprising statically verifying that the codelet deterministically terminates.

18. The method of claim 11, wherein to determining that the message is incompatible with a local configuration or interpretation of the standardized message comprises detecting an internal inconsistency within the message.

19. The method of claim 11, wherein to determining that the message is incompatible with a local configuration or interpretation of the standardized message comprises detecting that the message includes one or more known erroneous values.

20. The method of claim 11, further comprising advertising a service model for correcting interoperability issues.
